(19) United States
(12) Patent Application Publication
(10) Pub. No.: US 2011/0107394 A1
(43) Pub. Date: May 5, 2011

(54) AUTHENTICATION METHODS AND DEVICES

(76) Inventors: Nathan Stanley Jenne, Roseville, CA (US); Shaun Wakumoto, Roseville, CA (US)

(21) Appl. No.: 12/609,624

(22) Filed: Oct. 30, 2009

(51) Int. Cl. G06F 17/00

(52) U.S. Cl. 726/2

(57) ABSTRACT

Embodiments of the device have a plurality of authentication slots for authenticating users, a port configured to receive an authentication request from a user, a memory, a queue maintained in the memory, and a processing engine configured to monitor the port and the authentication slots such that if an authentication request from a user is received and no authentication slots are available, an identifier associated with the user is enqueued on the queue, and wherein if one of the authentication slots is or becomes available and the queue is not empty, an identifier is dequeued from the queue and the associated user is authenticated using one of the available authentication slots.

### TECHNICAL FIELD

Embodiments of the present invention relate generally to computer system technology, and more particularly to authentication techniques related to such systems.

### BACKGROUND ART

Authentication protocols are commonly used in computer systems to provide a form of access control. If a computer system (or a particular resource or component included therein) is intended by an administrator to be used only by particular authorized users, an authentication protocol is implemented to facilitate such access by detecting and excluding unauthorized users. Such access is typically controlled by the use of an authentication procedure to identify, with some predetermined degree of accuracy, the identity of a potential user. Select privileges can then be granted based on the identity. An example of a common authentication protocol requires that a user submit a username and password to gain access to a computer system. Typically, a query is then performed on a database to verify that the username and password are valid, which determines whether the user should be authenticated and given access to the system.

Due in part to the nature, size, and complexity of modern computer systems, it is often desired to have multiple users authenticated at one time. For example, multiple users may concurrently be authenticated and permitted to join a particular network. Such authentication systems are typically implemented through the use of select system resources (e.g., authentication slots maintained in a memory). However, as with any computer resource, these system resources are limited (e.g., amount of memory available, processing speed, etc.). Therefore, due to these limitations, authentication systems typically have a limit as to the number of concurrent authentications that can be maintained at one time.

### BRIEF DESCRIPTION OF THE DRAWINGS

FIG. 1 is a prior art authentication system;

FIG. 2 is a preferred embodiment of a device of the present invention;

FIG. 3 is a representation of a queue of the device of FIG. 2, the queue containing three identifiers;

FIG. 4 is a representation of a queue of the device of FIG. 2, the queue containing two identifiers;

FIG. 5 is a preferred embodiment of a device of the present invention;

FIG. 6 is a flow chart depicting a method of a preferred embodiment of the present invention; and

FIG. 7 is a flow chart depicting a method of a preferred embodiment of the present invention.

### DETAILED DESCRIPTION OF THE INVENTION

The use of a limit for concurrent authentications can lead to a potential problem involving malicious users. Malicious (or “spoofing”) users are unauthorized users, who attempt to gain unauthorized access to a system using various techniques. Common examples of malicious users are those who run username and/or password guessing programs. These programs result in the malicious user making repeated attempts to gain access to a system, by cycling through potential usernames and/or passwords until a valid pair is found. Attacks of this kind are often referred to as “brute-force” attacks, in that they attempt to acquire large quantities of valid usernames and passwords. Such attacks often flood the system and result in a denial of service to valid users wishing to authenticate. Another example of a malicious user is one which creates fictitious MAC addresses to trick a system into believing they represent a valid user. As multiple fictitious users attempt to authenticate themselves, they clog the authentication system, thereby preventing valid users from having the opportunity to authenticate.

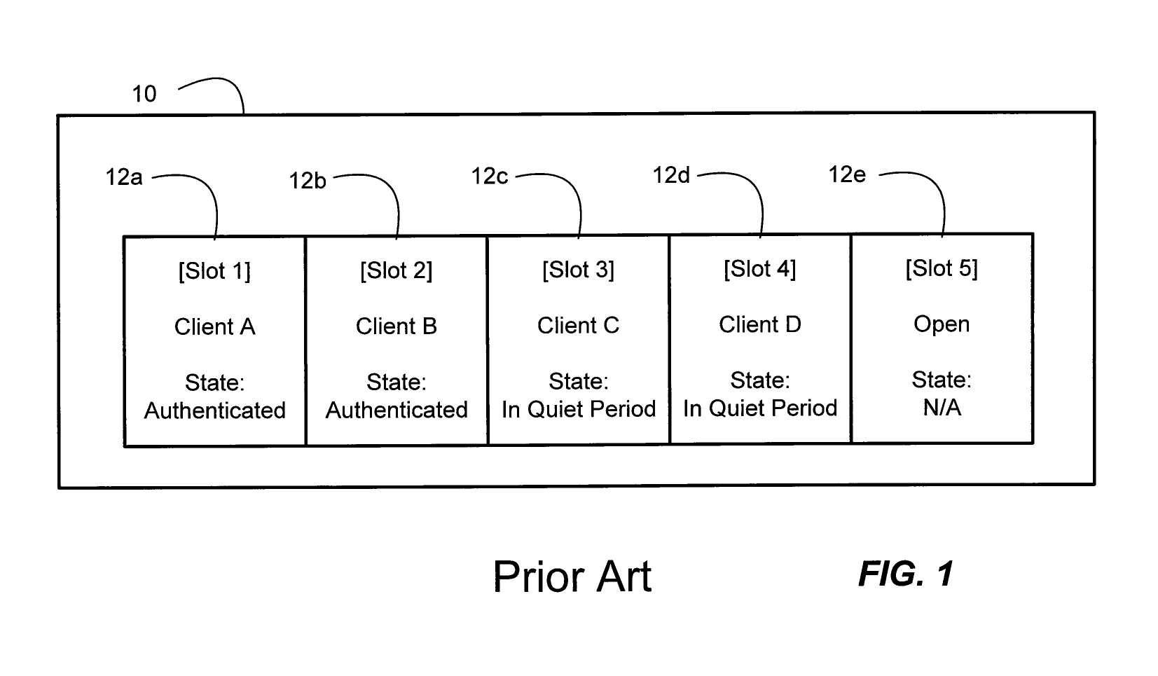

One approach to handling malicious users is to use a quiet period as part of the authentication protocol, which prevents a malicious user from making repeated and persistent unsuccessful authentication attempts. Referring now to FIG. 1, this technique is typically implemented at the server level, wherein the server 10 maintains a list of each of the available authentication slots 12a-e (five slots in this example). The authentication slots are sections of memory used to track users who attempt or have successfully been authenticated. Valid users Client A and Client B occupy Slots 1 and 2, respectively, and are authenticated pursuant to a predetermined protocol. When a user that makes an authentication request and fails (e.g., Client C and Client D), the user is placed into a quiet period and has to wait a predetermined amount of time (e.g., sixty seconds) before making its next authentication request. During the time when a user attempts an authentication, the resources of the authentication slot are in use and therefore the slots are temporarily unavailable. As such, slots 3 and 4 are temporarily unavailable following the authentication attempts of Clients C and D, but will become available shortly. In the example shown, Slot 5 is open and is available to authenticate a new user. Notably, once the quiet period for Clients C and D expire, they may make further authentication attempts using any available authentication slot. Notably, this quiet period technique is generally effective for handling a small number of malicious users, which submit multiple authentication requests in a short period of time.

However, when the number of malicious users is high, the described quiet period technique is often ineffective. Indeed, even with a quiet period, if there are enough malicious users, there can be a steady stream of malicious users ending their quiet period such that they continually clog the available authentication slots, thereby continually preventing authentication attempts from valid users.

Throughout this disclosure, reference to “a,” “an,” or “the” refers to at least one unless otherwise specified. Embodiments of the invention provide an authentication method and device wherein a “standby” queue is used to promote fairness with respect to authentication slot allocation by ensuring that all users will eventually have an opportunity to be authenticated. Therefore, even if a large number of malicious users make authentication attempts, they will not completely monopolize use of the available authentication slots without affording the valid users the opportunity to authenticate.

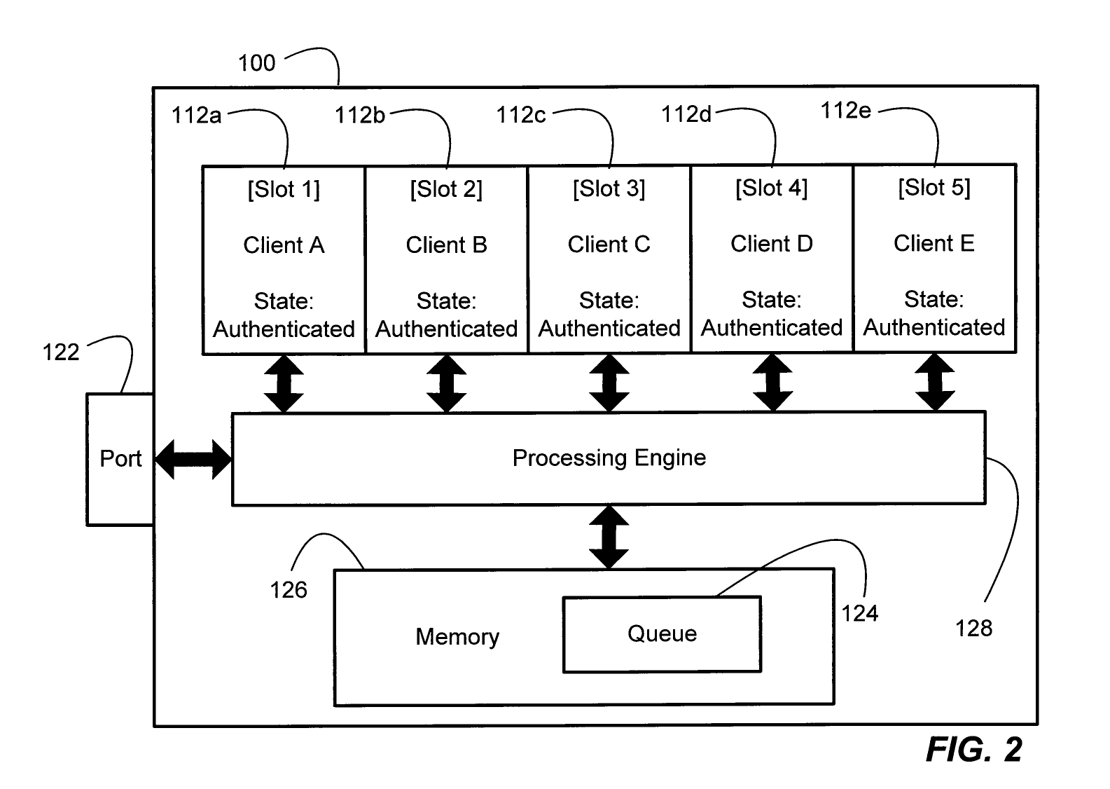

Referring now to FIG. 2, in a preferred embodiment, a device 100 is shown with five authentication slots 112a, 112b, 112c, 112d, and 112e (referred to collectively as 112) for authenticating users. A port 122 is included on the device 100 and is configured to receive an authentication request from a user. Further included is a queue 124, which is maintained in a memory 126 on the device 100. Finally, a processing engine 128 provides communication between the authentication slots 112, the port 122, and the queue 124 residing in memory 126. Notably, the device 100 is not limited to any particular type of device, but is preferably a network switch device such as a layer-2 or layer-3 network switch or another network device having limited resources. Notably, while some network devices such as a workstation often have a considerable amount of memory and many authentication slots (e.g., 2 gb of memory and 100 slots), many devices have much more stringent limitations. For example, a non-workstation network device may have only 128 mb of memory and only 10 slots, and therefore likely runs a higher risk of congestion-related issues caused by malicious users.

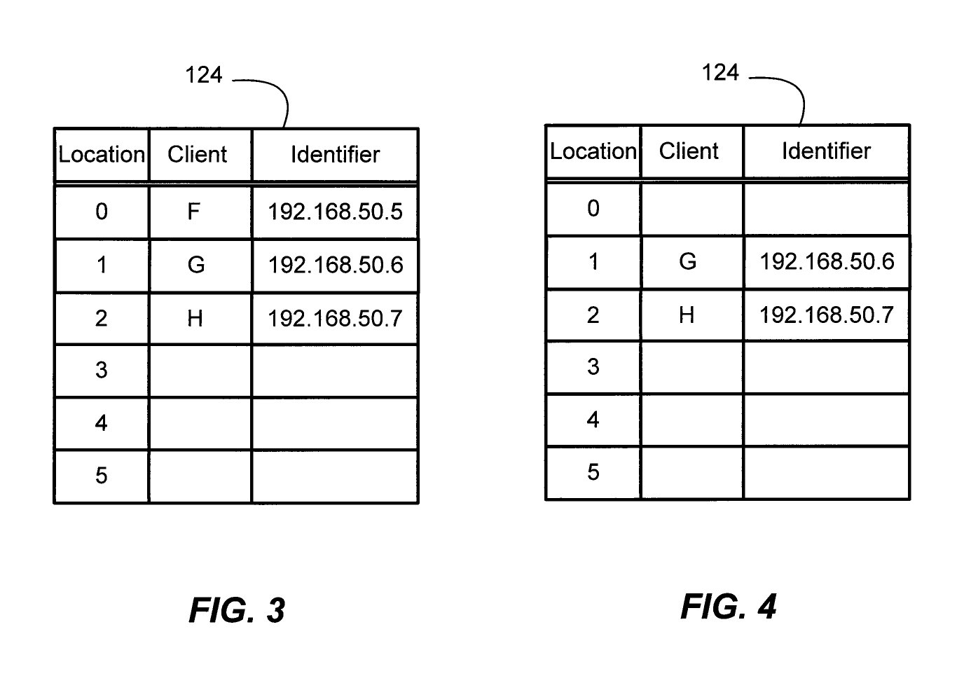

The processing engine 128 is configured to monitor the port 122 and the authentication slots 112 such that if an authentication request from a user is received and no authentication slots are available, an identifier associated with the user is added to on the queue 124 (i.e., enqueued). In the example shown, all five slots 112 are in use. Therefore, when a new user (e.g., Client F) attempts to authenticate, an identifier associated with Client F will be enqueued into the queue 124. In this example, the identifier is an IP address of the client, however other identifiers (e.g., MAC address or username) are considered and could be used instead. Consider now two additional users Client G and Client H, which attempt to authenticate, but are rejected because no authentication slots 112 are available. FIG. 3 depicts the queue 124 after Clients F, G, and H have been enqueued in this order.

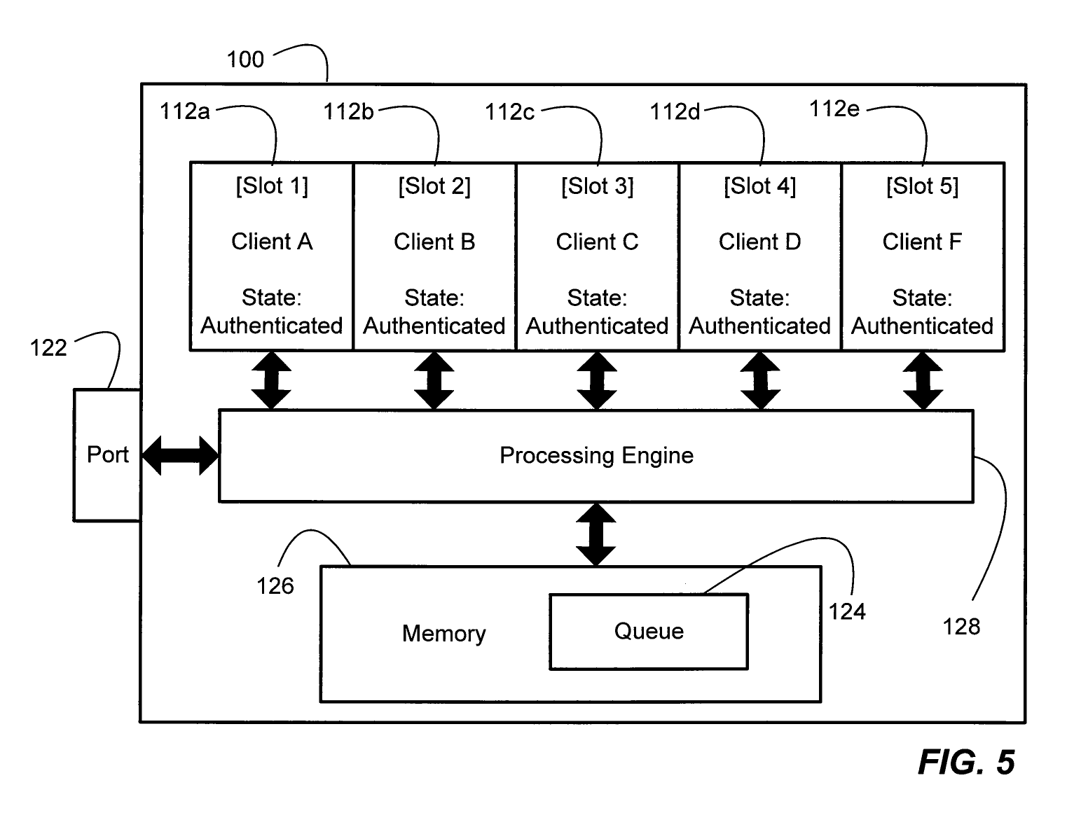

Concurrently, the processing engine 128 monitors the authentication slots 112 and the queue 124 such that if one of the authentication slots 112 becomes available and the queue 124 is not empty, the processing engine 128 causes an identifier to be removed from the queue 124 (i.e., dequeued) and causes the associated user to be authenticated using one of the available authentication slots. Therefore, when Slot 5 112e, previously allocated by Client E, becomes available, Client F is dequeued from the queue 124 and authenticated using authentication Slot 5 112e. The revised queue 124 and device 100 after these steps are shown as FIGS. 4 and 5. Notably, if the user does not have the proper authentication credentials, it will fail authorization. If another attempt is made, the user is enqueued again in the bottom of the queue 124 and has to wait its turn before the next authentication attempt. However, notably such an authentication attempt would be performed by the user as the device 100 does not automatically reattempt authentication.

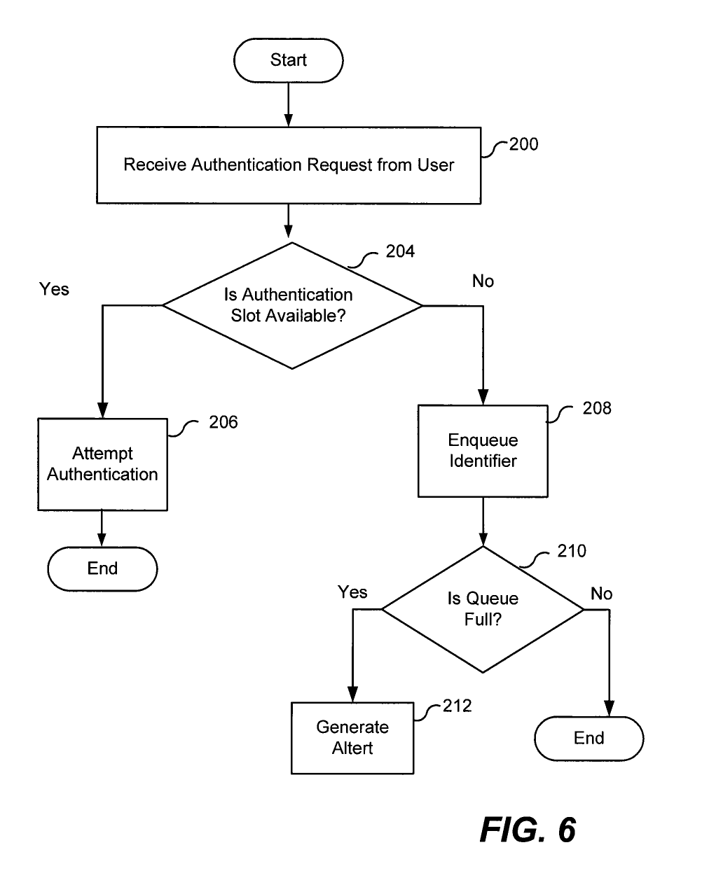

Referring now to FIG. 6., the preferred embodiment of the present invention will now be discussed with respect to the steps depicted in flow chart form. To implement the preferred method of user authentication for a device 10, in Step 200, the port 122 on the device 100 receives and authentication request from a user. In Step 204, a query is performed to determine whether the device 100 has an available authentication slot 112. If there is an available authentication slot 112, in Step 206 an authentication attempt is made. If there is no available authentication slot 112, in Step 208, an identifier associated with the user is enqueued on a queue 124 stored in a memory 126 on the device 100. At Step 210, a query is made to determine whether the queue 124 is full. If the queue 124 is full, at Step 212, an alert is generated and sent to the administrator or another designated recipient.

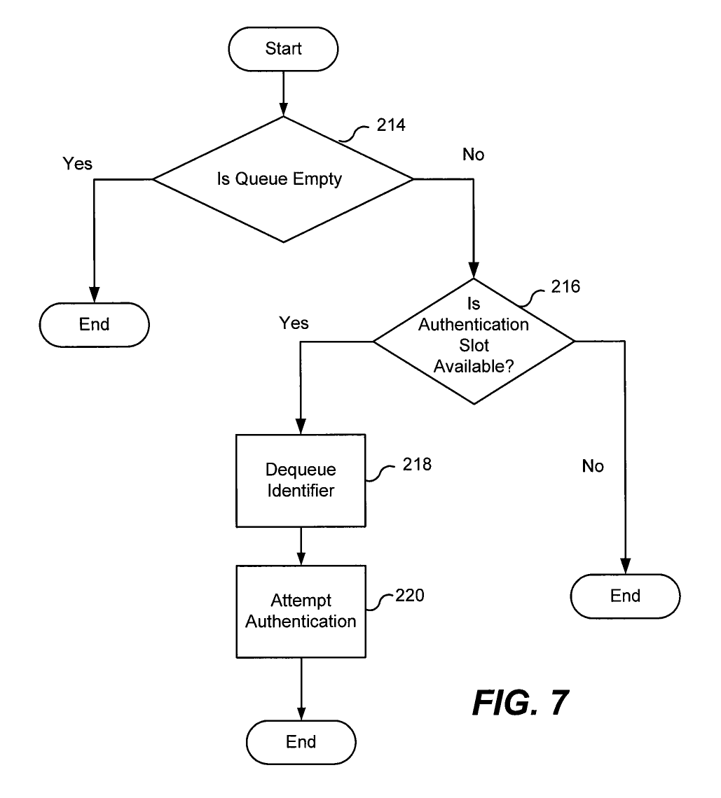

In the preferred embodiment, a concurrent series of steps are also performed as depicted in the flow chart in FIG. 7. In Step 214, a query is performed to determine whether the queue 124 is empty. If the queue 124 is not empty, a second query is performed at Step 216 to determine whether there is an available authentication slot 112. If a slot is available, the next identifier is dequeued from the queue 124 at step 218, and the associated user is authenticated using an available authentication slot 112 at Step 220.

Each of the steps described above are preferably carried out by the processing engine 128, which can be implemented using, among other things, hardware, software (i.e., instructions stored on a computer-readable medium), or a combination of both. However, notably the steps can also be performed manually and/or by other components in the authentication system.

In the described embodiments, the use of the queue 124 ensures that all users (whether valid or malicious) are provided with an opportunity to attempt an authorization. This provides an advantage over the quiet period technique in that valid users need not rely on having the appropriate timing to be authenticated. Indeed, consider an authentication system having one remaining available authentication slot 112, with one hundred malicious users and a single valid user competing for the slot. While the malicious users will be placed in a quiet period when they fail the authentication attempt, the sheer number of malicious users makes it likely that they will continually be completing their quiet periods and making new user-initiated authentication attempts such that they effectively blocking the valid user. Indeed, the valid user would only able to authenticate if it were to submit an authentication request at exactly the right time (i.e., as soon as the one slot becomes, but before any of the one-hundred malicious users makes an attempt and temporarily makes the slot unavailable). This results in a timing game, which needs to be played by the valid user in order to successfully authenticate.

However, the above described embodiment avoids this timing game, by ensuring that each user is sequentially given an opportunity to attempt an authentication. As each of the one hundred malicious users and the single valid user attempt authentication, but are denied because the slot is not available, each will be placed into the queue 124. As such, when the slot becomes available, a new user will be dequeued from the queue 124 and submitted for an attempted authentication. While the queue 124 will still maintain several malicious users, each will continually be denied authentication resulting in the valid user being moved up sequentially in the queue 124. Eventually, the valid user will be afforded its turn and will successfully authenticate with the available slot.

Notably, the size of the queue 124 is adjustable and is set by an administrator depending on the conditions of the computer system, its required functionality, and other limitations (e.g., available memory resources). In the example described above, a queue 124 of at least the size one-hundred and one would be required to ensure that each user is guaranteed an authentication request opportunity (for simplicity, the queues shown in FIGS. 3 and 4 only show six entry fields). Indeed, if the number of malicious users exceeds the size of the queue 124, clogging of the queue could result, providing a similar timing problem as described above, but this time is related to entry of the user in the queue. Therefore, a queue 124 of sufficient size should be considered when implementing the described embodiment. To reduce concerns about proper sizing of the queue 124, the processing engine 128 preferably generates an alert if the queue becomes full. For example, the processing engine 128 would send an electronic mail message to a system administrator indicating that the current queue size may be insufficient and should be modified. Other types of alerts and/or automatic queue size correction algorithms could also be employed to address issues related to the size of the queue 124.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A device comprising:
a plurality of authentication slots for authenticating users;
a port configured to receive an authentication request from a user;
a memory;
a queue maintained in said memory; and
a processing engine configured to monitor said port and said authentication slots such that if an authentication request from a user is received and no authentication slots are available, an identifier associated with the user is enqueued on said queue, and
wherein if one of said authentication slots is or becomes available and said queue is not empty, an identifier is dequeued from said queue and the associated user is authenticated using one of said available authentication slots.

2. The device of claim 1 wherein said device is a layer-2 network switch.

3. The device of claim 1 wherein said device is a layer-3 network switch.

4. The device of claim 1 wherein the identifier associated with the user is a MAC address.

5. The device of claim 1 wherein the identifier associated with the user is an IP address.

6. The device of claim 1 wherein the identifier associated with the user is a username.

7. The device of claim 1 wherein said processing engine generates an alert if said queue becomes full.

8. A method of user authentication for a device comprising the steps of:
receiving on a port of the device, an authentication request from a user;
determining whether the device has an available authentication slot;
enqueueing an identifier associated with the user on a queue stored in a memory associated with the device if no authentication slots are available; and
dequeueing an identifier from said queue and authenticating the associated user using an available authentication slot if an authentication slot is available and the queue is not empty.

9. The method of claim 8 wherein the device is a layer-2 network switch.

10. The method of claim 8 wherein the device is a layer-3 network switch.

11. The method of claim 8 wherein the identifier associated with the user is a MAC address.

12. The method of claim 8 wherein the identifier associated with the user is an IP address.

13. The method of claim 8 wherein the identifier associated with the user is a username.

14. The method of claim 8 wherein said processing engine generates an alert when said queue is full.

15. A computer-readable medium associated with a device, containing instructions for executing the steps of:
monitoring a port of the device to determine whether an authentication request from a user has been received;
if an authentication request has been received, determining whether the device has an available authentication slot, and if no authentication slots are available, enqueueing an identifier associated with the user on a queue stored in a memory on the device, and
determining whether the device has an available authentication slot and if an authentication slot is available and the queue is not empty, dequeueing an identifier from said queue and authenticating the associated user using an available authentication slot.

16. The computer-readable medium of claim 15 wherein the device is a network switch.

17. The computer-readable medium of claim 15 wherein the identifier associated with the user is a MAC address.

18. The computer-readable medium of claim 15 wherein the identifier associated with the user is an IP address.

19. The computer-readable medium of claim 15 wherein the identifier associated with the user is a username.

20. The computer-readable medium of claim 15 wherein said medium further includes instructions for generating an alert when the queue is full.
